(19) United States
(12) Patent Application Publication
(10) Pub. No.: US 2009/0135154 A1
(43) Pub. Date: May 28, 2009

(54) Handheld device and operating method thereof

(75) Inventor: Pang-Ruei Huang, Taipei (TW)

Correspondence Address: REED SMITH LLP, Suite 1400, 3110 Fairview Park Drive, Falls Church, VA, 22042, US

(73) Assignee: Compal Communications, Inc.

(21) Appl. No.: 12/292,659

(22) Filed: Nov. 24, 2008

(30) Foreign Application Priority Data
Nov. 23, 2007 (TW) 096144394

(51) Int. Cl. G06F 3/041

(52) U.S. Cl. 345/173

(57) ABSTRACT

The invention provides a handheld device comprising an electronic paper, a control module and a touch module. When the handheld device is under a first input mode, the control module controls the electronic paper to show a first input image. Additionally, when the handheld device is under a second input mode, the control module controls the electronic paper to show a second input image. The touch module positioned beneath the electronic paper is used to sense a touch pressure acted on the electronic paper, so as to generate an input signal to manipulate the handheld device.

### BACKGROUND OF THE INVENTION

1. Field of the Invention

The invention relates to a handheld device, and more particularly, to a method of operating an input interface of a handheld device.

2. Description of the Prior Art

With the rapid growth of mobile communication technology, mobile phones have already become a necessary tool in our daily life. However, the mobile phones on the market presently still use a fixed keyboard or a touch panel as their input interface. Since the mobile phones have more functions and larger application regions currently, the fixed keyboard input interface can not meet the requirement of users.

For example, when a user wants to use the mobile phone to edit a short message, the user have to spend a lot of time to find out which of the keys corresponds to which characters respectively and adapt to it, so that he/she can correctly input each word. This is inconvenient for most users. Although the touch panel is more convenient than the fixed keyboard for handwriting input, its cost is too high.

Therefore, the main scope of the invention is to provide a handheld device and a method of operating an input interface of the handheld device to solve the above-mentioned problems.

### SUMMARY OF THE INVENTION

The invention provides a handheld device and a method of operating an input interface of the handheld device. In the handheld device, the invention uses an electronic paper to replace the inconvenient fixed input interface, and combines the touch device and man machine interface (MMI) software to form an input interface which can show the corresponding input mode automatically according to different types of input requirements.

An embodiment according to the invention is a handheld device. The handheld device comprises an electronic paper, a controlling module, and a touch module. When the handheld device is under a first input mode, the control module controls the electronic paper to show a first input image, and when the handheld device is under a second input mode, the control module controls the electronic paper to show a second input image. The touch module is positioned beneath the electronic paper and used for sensing a touch pressure acted on the electronic paper to generate an input signal to manipulate the handheld device.

The advantage and spirit of the invention may be further understood by the following recitations together with the appended drawings.

### BRIEF DESCRIPTION OF THE APPENDED DRAWINGS

FIG. 1 shows a functional block diagram of the handheld device in the first embodiment according to the invention.

FIG. 2 shows a functional block diagram of the handheld device shown in FIG. 1 further comprising a capacitive touch panel.

FIG. 3 shows a flowchart of the handheld device input interface controlling method in the second embodiment according to the invention.

FIG. 4 shows an example of the handheld device input interface controlling method.

### DETAILED DESCRIPTION OF THE INVENTION

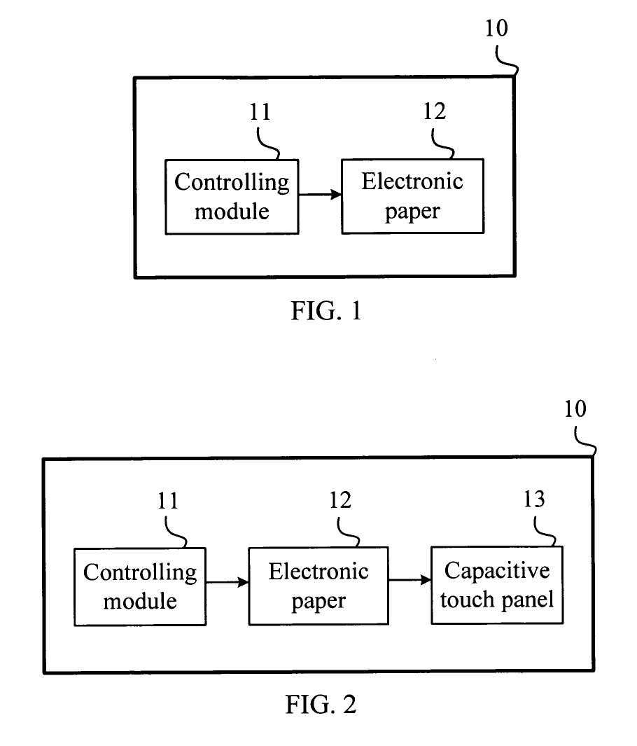

A first embodiment according to the invention is a handheld device. The handheld device can be a mobile phone, a personal digital assistant (PDA), or any other kind of mobile communication apparatus. Please refer to FIG. 1. FIG. 1 shows a functional block diagram of the handheld device. As shown in FIG. 1, the handheld device 10 comprises an electronic paper 11 and controlling module 12.

It should be noted that in this invention, the electronic paper 11 is used on the input interface of the handheld device 10 instead of being used on the displaying monitor of the handheld device 10. When the handheld device 10 is under a first input mode, the control module 12 controls the electronic paper 11 to show a first input image, and when the handheld device 10 is under a second input mode, the control module 12 controls the electronic paper 11 to show a second input image.

In practical applications, the handheld device 10 can further comprise a man machine interface (MMI). A user can select a function option from a plurality of function options of the handheld device 10 through the MMI.

For example, if the first input mode of the mobile input interface is a communication mode, then the first input image can comprise a plurality of number patterns (e.g., 0˜9) for a user to dial the telephone number. When the user wants to use the mobile phone to make a call, he/she only needs to select the communication function from all functions shown on the screen of mobile phone through the MMI, then the input interface of the mobile phone will automatically show the dialing number keys for the user to dial the telephone number to make a call.

Additionally, if the second input mode of the mobile input interface is a short message mode, then the second input image can comprise a handwriting input window or an input method editing mode for the user to input. Namely, when the user wants to use the mobile phone to send a short message, he/she only needs to select the short message function from all functions shown on the screen of mobile phone through the MMI, then the input interface of the mobile phone will automatically show the default input method editing mode or the handwriting input window for the user to edit the content of the short message.

Similarly, if the user wants to operate the mobile phone to perform other functions, he/she only needs to select a function he/she wants to use from all functions shown on the screen of the mobile phone through the MMI, then the mobile phone will automatically switch from the default input interface to the input interface corresponding to the function. For example, when the user wants to use the mobile phone to calculate numbers, he/she only needs to select the calculation function from all functions shown on the screen of mobile phone through the MMI, then the input interface of the mobile phone will automatically show the calculating keys like a calculator for the user to calculate.

In practical applications, as shown in FIG. 2, the handheld device 10 can further comprise a touch module 13. Because the light transmittance rate of the touch module 13 can not reach 100%, the touch module 13 of the invention is positioned beneath the electronic paper 11 and used for sensing a touch pressure acted on the electronic paper 11. Thus, the user can see the input interface shown on the electronic paper 11 more clearly.

To make each of all keys shown on the input interface of the handheld device 10 to correctly correspond to the corresponding function respectively, the handheld device 10 of the invention can divide different function blocks by changing the characteristic of the touch blocks on the input interface through software.

Additionally, in another application case, the handheld device 10 of the invention can also use software for the user to freely set up the positions of the different keys shown on the input interface. For example, the default condition is assumed that the handwriting input window is positioned at the upper side of the second input image and the function controlling toolbar is positioned at the lower side of the second input image. If the user feels uncomfortable about this default condition, he/she can move the function controlling toolbar to the left side of the second input image and move the handwriting input window to the right side of the second input image.

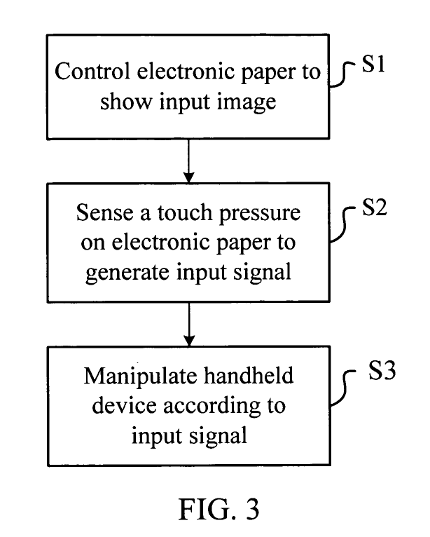

A second embodiment according to the invention is a method of operating an input interface of a handheld device. Please refer to FIG. 3. FIG. 3 shows a flowchart of the method.

As shown in FIG. 3, the method performs step S1 to control the electronic paper to show an input image, and the input image corresponds to an input mode of the handheld device. For example, when the input interface of the handheld device is under a first input mode, the method controls the electronic paper to show a first input image; when the input interface of the handheld device is under a second input mode, the method controls the electronic paper to show a second input image.

Then, the method performs step S2 to sense a touch pressure acted on the electronic paper to generate an input signal. For example, the handheld device can use a capacitive touch device or any other kind of touch devices to generate the input signal. After the input signal is generated, the method performs step S3 to manipulate the handheld device according to the input signal.

In practical applications, the handheld device can comprise a man-machine interface (MMI); the method can further select a function option from a plurality of function options of the handheld device through the MMI. The function option can be a game function, a handwriting input function, or a dialing function.

Taking a mobile phone for example, if the user wants to use the mobile phone to perform a certain function, he/she only needs to select the function he/she wants to use from all functions shown on the screen of mobile phone through the MMI, then the mobile phone will automatically show the corresponding input interface.

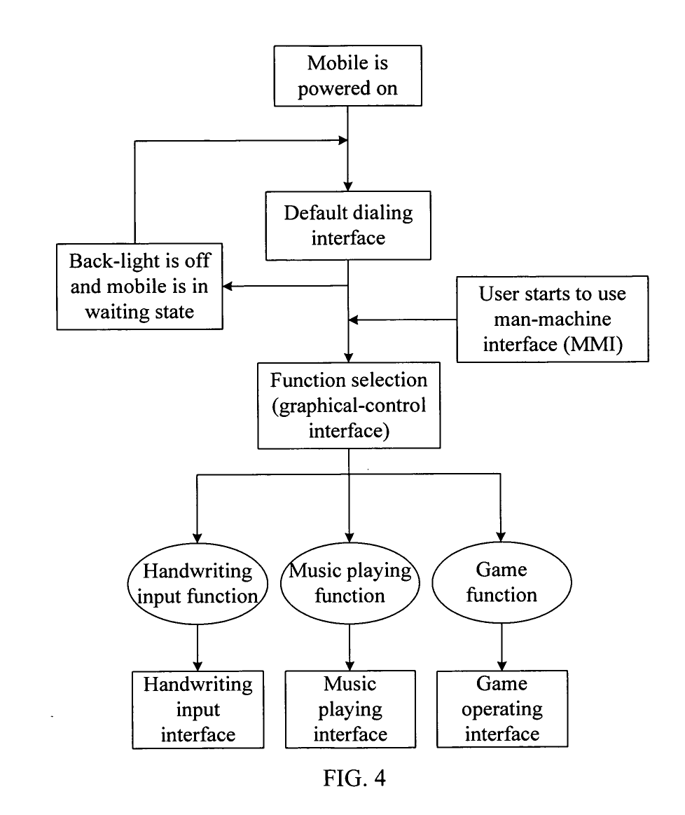

As shown in FIG. 4, if the default input interface shown on the screen of the mobile phone is a dialing interface, and the user wants to play games on the mobile phone, he/she only needs to select a game function from all functions shown on the screen of the mobile phone through the MMI, then the method will control the input interface of the mobile phone to show a game operating interface corresponding to the game for the user to play the game. Similarly, if the user selects a music playing function, the method will control the input interface of the mobile phone to show a music playing interface for the user to play music.

Compared with the prior art, the handheld device and the handheld device input interface operating method according to the invention use an electronic paper to replace the inconvenient fixed input interface, and combine a touch device and man machine interface (MMI) software to form an input interface which can show the corresponding input mode automatically according to different types of input requirements. The above-mentioned variable displaying input interface has several advantages such as low cost, programmable, and user-friendliness. If a user uses a different language in another country, and he/she wants to use the mobile phone, the mobile phone is only needed to change the software setup to change the input interface shown in that language without doing any change to the hardware of the mobile phone, therefore, the material costs will be saved.

With the recitations of the preferred embodiment above, the features and spirits of the invention will be hopefully well described. However, the scope of the invention is not restricted by the preferred embodiment disclosed above. The objective is that all alternative and equivalent arrangements are hopefully covered in the scope of the appended claims of the invention. Accordingly, the above disclosure should be construed as limited only by the metes and bounds of the appended claims.

What is claimed is:

1. A handheld device, comprising:
an electronic paper;
a controlling module, coupled to the electronic paper, when the handheld device is under a first input mode, the control module controlling the electronic paper to show a first input image, and when the handheld device is under a second input mode, the control module controlling the electronic paper to show a second input image; and
a touch module, positioned beneath the electronic paper, for sensing a touch pressure acted on the electronic paper to generate an input signal to manipulate the handheld device.

2. The handheld device of claim 1, wherein the first input mode is a communication mode, and the first input image comprises a plurality of number patterns.

3. The handheld device of claim 1, wherein the second input mode is a short message mode, and the second input image comprises a handwriting input window.

4. The handheld device of claim 1, further comprising:
a man-machine interface (MMI), for a user to select a function option from a plurality of function options of the handheld device through the MMI.

5. The handheld device of claim 4, wherein the function option is a game function, a handwriting input function, or a dialing function.

6. A method of operating a handheld device, the handheld device comprising an electronic paper, the method comprising the steps of:
controlling the electronic paper to show an input image, wherein the input image corresponds to an input mode of the handheld device;
sensing a touch pressure acted on the electronic paper to generate an input signal; and
manipulating the handheld device according to the input signal.

7. The method of claim 6, wherein the input mode is a communication mode, and the input image comprises a plurality of number patterns.

8. The method of claim 6, wherein the input mode is a short message mode, and the input image comprises a handwriting input window.

9. The method of claim 6, wherein the handheld device comprises a man-machine interface (MMI), the method further comprises the step of:
selecting a function option from a plurality of function options of the handheld device through the MMI.

10. The method of claim 9, wherein the function option is a game function, a handwriting input function, or a dialing function.
